(19) United States
(12) Patent Application Publication
(10) Pub. No.: US 2010/0015339 A1
(43) Pub. Date: Jan. 21, 2010

(54) SILANE-CONTAINING CORROSION PROTECTION COATINGS

(75) Inventors: Ramon Sanchez MORILLO, West Milford, NJ (US); Doris SIMOES, Clark, NJ (US)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/390,831

(22) Filed: Feb. 23, 2009

Related U.S. Application Data
(60) Provisional application No. 61/034,814, filed on Mar. 7, 2008.

(51) Int. Cl. B05D 3/00

(52) U.S. Cl. 427/327; 427/387

(57) ABSTRACT

A metal surface can be corrosion protected by coating a corrosion protection composition on the metal surface, thereby obtaining a coating; and curing said coating at a temperature of from 20 to 120° C., to obtain a cured coating; wherein said corrosion protection composition comprises a condensated and hydrolyzed oligomer and/or polymer of at least one functionalized silane.

### BACKGROUND OF THE INVENTION

1. Field of the Invention

The present invention relates to a low temperature curing process for silane-based compositions and their use as corrosion protection coatings.

2. Discussion of the Background

Corrosion damages of metal materials and metal parts are of significant economic importance. Corrosion protective coatings are applied to protect corrosion sensitive parts, used, for example, in construction, automobile industry and household. Conventional coating systems comprise several individual layers, typically the layers are on metals, and in particular “heavy” metals, e.g. chromium, nickel, arsenic, cobalt and zinc are often part of such coating. These metals have health and ecological risks, and thus alternatives are being searched.

Silanes have been tested as possible substitutes for traditional pre-treatments of metal surfaces and more specifically to substitute Chrome VI. Silanes react with many inorganic surfaces, e.g. glass, ceramic and metals, and form a coating on the surface. For this reason, silanes are used commercially for glass coatings. Silanes are rarely used commercially as an adhesion promoter on metal surfaces. In such applications silanes are added to the coating (for example a lacquer), or applied as a primer dissolved in a solvent. Such formulations are used in the industrial production in only very few circumstances due to the fact that industrial manufacturing does not have the capabilities to handle solvent containing pre-coating systems.

DE 41 38 218 describes a formulation of an aqueous silane-containing corrosion protection composition. Such coating is applied merely for zinc plating coatings or chromium plated metal parts.

DE 198 14 605 describes an aqueous silane containing sealing system. This system contains a silica sol. Such coatings become very brittle and it is difficult to lacquer such brittle coatings. Furthermore, such coatings are only applicable to zinc and zinc alloys.

U.S. Pat. No. 6,955,728 also describes aqueous silanes used as corrosion inhibitor. In particular, a mixture of two different monomeric silanes in water is described that is applied onto a metal surface for increased corrosion protection. The preparation of the silane mixtures includes silanes containing alcohol residues. Such silane formulations release large amounts of alcohol, e.g. A 1170 mentioned in the examples releases more than 50% alcohol during the hydrolysis. Another disadvantage is that these formulations cannot be stored. Monomeric silanes hydrolyze and condensate easily to larger structures and thus do not have the same reactivity. Water stable solutions of such monomeric silanes are prepared only by reacting mixtures of silanes having a corrosion protection property (e.g. bisaminosilanes) and a silane that are both stable in water and miscible in an aqueous environment. The bisaminosilanes are not soluble in water, or only very little. Such systems exhibit only a corrosion protection effect when these bisaminosilanes are cured at more than 100° C. It is required to also control the pH, thus preventing pH adjustment needed for specific metals.

### SUMMARY OF THE INVENTION

Accordingly, it was an object of the present invention to provide a low temperature curing process for silane-based compositions and their use as corrosion protection coatings.

This and other objects have been achieved by the present invention the first embodiment of which includes a method for corrosion protection of a metal surface, comprising:

coating a corrosion protection composition on said metal surface, thereby obtaining a coating; and

curing said coating at a temperature of from 20 to 120° C., to obtain a cured coating;

wherein said corrosion protection composition comprises a condensated and hydrolyzed oligomer and/or polymer of at least one functionalized silane.

### BRIEF DESCRIPTION OF DRAWINGS

FIG. 1 shows a schematic of an organosilane condensation process.

FIG. 2 shows the scribing of a metal panel.

FIG. 3 shows a Q-Fog salt spray cabinet.

FIG. 4 shows the panel set-up in the Q-Fog cabinet for the corrosion test according to ASTM B117.

FIG. 5 shows the results of the corrosion test according to ASTM B117.

FIG. 6 shows the results of the corrosion test according to ASTM D-1654-05.

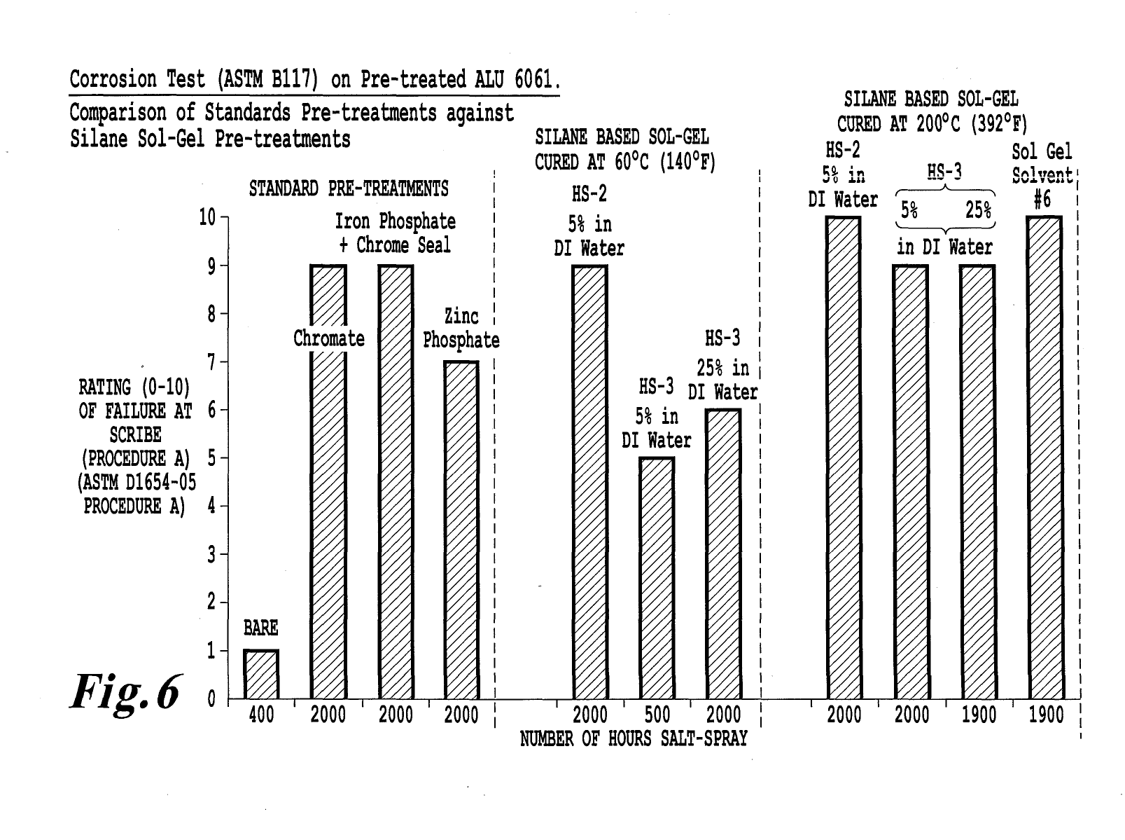

### DETAILED DESCRIPTION OF THE INVENTION

The inventors of the present invention have found that hydrolyzed condensed oligomers and/or polymers of functionalized silanes, where the produced alcohol of the condensation reaction has been removed and reduced to less than 0.5%, preferably less than 0.3%, exhibit corrosion protection, when applied to metal surfaces and cured at low temperatures.

The condensated and hydrolyzed oligomers and/or polymers of functionalized silanes are a result of controlled reaction between monomeric functional silanes, including hydrolization of alkoxy groups and removal of the produced alcohol. The resulting condensated and hydrolyzed oligomers and/or polymers of functionalized silanes are preferably used as aqueous systems having a low VOC content (volatile organic compound)—hereafter also called “hydrosils”, “hydrosil system” or “HS”. The condensated and hydrolyzed oligomers and/or polymers of functionalized silanes may be basic aqueous systems or acidic aqueous systems, preferably low acidic systems. The pH may be adjusted depending on the application. For applications to metals such as steel it may be necessary to adjust the pH to about or above 7, preferably to about 7.

Preferably, the condensated and hydrolyzed oligomers and/or polymers of functionalized silanes used in the present invention are commercially available DYNASYLAN® HYDROSILs from Evonik Degussa GmbH. Preferably, the condensated and hydrolyzed oligomers and/or polymers of functionalized silanes carry groups that make them reactive. Preferably, the condensated and hydrolyzed oligomers and/or polymers of functionalized silanes used in the present invention are sol-gel formulations.

DYNASYLAN® HYDROSILs are reactive organofunctional siloxane oligomers and/or polymers in water. They can be used directly as they are as aqueous systems or if required with additives to adjust the pH, additives for air release or flow improvement. The concentration of the condensated and hydrolyzed oligomers and/or polymers of functionalized silanes in water may vary between 0.5 to 99.5% by weight, preferably the concentration is between 40 to 80% by weight, more preferably the concentration is between 5 to 25% by weight. The amount of the present condensated and hydrolyzed oligomers and/or polymers of functionalized silanes in water includes all values and subvalues therebetween, especially including 1, 2, 3, 4, 5, 6, 7, 8, 9, 10, 15, 20, 25, 30, 35, 40, 45, 50, 55, 60, 65, 70, 75, 80, 85, 90, 95, and 99% by weight.

The above mentioned condensated and hydrolyzed oligomers and/or polymers of at least one functionalized silane can be also diluted in a mixture of water and organic solvent. The organic solvent is not particularly limited as long as it mixes with water. Preferably, polar organic solvents are used, for example alcohols. Preferably, IPA (iso-propanol) is used. Further, an appropriate catalyst or activators such as an organic acid (preferably, acetic acid or formic acid) or an inorganic acid (typically, but not limited to hydrochloric acid) or mixtures thereof may be added. If appropriate, other additives such as silica derivatives, zirconates, titanates, etc. may be used.

Once the metal surfaces have been degreased, cleaned and dried, the hydrosil can be applied. It can be applied with any of the usual methods, i.e. using brushing, dipping, spraying, or with any other applicator.

Conventionally, condensated and hydrolyzed silane oligomers and/or polymers of functionalized silanes have been cured at temperatures as high as 150° C. (302° F.), and in some cases 180° C. (356° F.) and even 200° C. (392° F.) when used as pre-treatment of metal surfaces prior to painting. For example, for sol-gel formulations, it is conventionally thought that the final curing can require temperatures from room temperature to very high temperatures in the order of 200° C. It is conventionally thought that silane based sol-gel formulations require temperatures between 150 and 200° C. in order to create a cross linking between the sol particles. If not cured at high temperatures, the sol-gel will remain a sol.

Conventional curing at high temperatures is for example mentioned in the technical paper from Evonik Industries regarding DYNASYLAN® HYDROSILs available from the web-site www.dynasylan.com/dynasylan/en/markets/coatings/adhesion/. Here it is described that a primer solution of DYNASYLAN® HYDROSIL is cured at 150° C. Another technical paper referred to as “DYNASYLAN® Primers” found at the website www.specialchem4coatings.com/documents/indexables/contents/32/include/Primer.pdf, which describes the curing of hydrosils at 150° C.

However, these high curing temperatures have limited use in industrial applications in view of energy, cost and equipment demands.

Accordingly, the inventors of the present invention have now found that coatings of condensated and hydrolyzed oligomers and/or polymers of functionalized silanes applied to metal surfaces can be cured at temperatures of between room temperature and less than 150° C., for example 100 to 120° C., particularly between room temperature and 60° C. preferably 20 to 60° C., more preferably 25 to 55° C., even more preferably 30 to 50° C., most preferably 50-60° C. The curing temperature includes all values and subvalues therebetween, especially including 25, 30, 35, 40, 45, 50, 55, 60, 65, 70, 75, 80, 85, 90, 95, 100, 105, 110, 115, 120, 125, 130, 135, 140 and 145° C. The resulting cured coating of the condensated and hydrolyzed oligomers and/or polymers of functionalized silanes exhibits excellent corrosion protection properties.

Condensated and Hydrolyzed Silane Oligomers and/or Polymers of Functionalized Silanes

The condensated and hydrolyzed oligomers and/or polymers of functionalized silanes used in the present invention are a result of a controlled reaction between monomeric functional silanes. The alcohol of the condensation reaction has been removed and reduced to less than 5%, preferably to less than 3, more preferably to less than 0.5%, even more preferably to less than 0.3%, most preferably to less than 0.1%, including 0% by weight based on the weight of the aqueous system. The amount of alcohol from the condensation reaction includes all values and subvalues therebetween, especially including 0.1, 0.2, 0.3, 0.4, 0.5, 0.6, 0.7, 0.8, 0.9, 1, 1.1, 1.2, 1.3, 1.4, 1.5, 2, 2.5, 3, 3.5, 4, and 4.5% by weight.

Functionalized monomeric silanes used for the formation of the condensated and hydrolyzed oligomers and/or polymers of functionalized silanes are for example, but not limited to amino-, diamino- and triamino-silanes, alkylsilanes, mercaptosilane, arylsilanes such as phenylsilanes, methacrylsilanes, glycidyloxysilanes, fluoroalkylsilanes, vinylsilanes. Examples of the structure and synthesis of condensated and hydrolyzed oligomers and/or polymers of at least one functionalized silane are described, for example, in EP 0675128, EP 0953591, EP 0716128, EP 0716127, EP 0832911 and EP 1031593, each of which are incorporated herein by reference.

In one embodiment, the oligomer and/or polymer has a cyclic, linear or branched structure represented by the formulae (Ia) or (Ib)

HO—[SiR¹(OH)—O]ₐ—[SiR²(OH)—O]_{b}—H (Ia),or

HO—[SiR¹(OH)—O]ₐ—[SiR²(OH)—O]_{b}—[Si(OH)₂—O]_{c}—H (Ib)

wherein R¹ and R², are each independently, a linear or branched alkyl group having no substitution or at least one functional group selected from the group consisting of an alkylamino-, arylamino-, glycidyl-, alkyldiamino-, alkyltriamino-, hydrolyzed glycidyl-, methacryloxy-, acryloxy-, vinyl-, aryl-, fluoroalkyl-, polyethylenoxide- and alkylamine-N-alkyl-group, and wherein a, b and c are each independently smaller than 300, with c≧0. In addition, a, b and c are each independently preferably ≧0 and ≦300, preferably ≦150, more preferably ≦80, even more preferably ≦60, most preferably ≦40. Further, (a+b+c) is preferably <300, more preferably ≦200, even more preferably ≦100, most preferably ≦50. All subvalues are included.

In one embodiment, the oligomer and/or polymer is from the series of alkyl- or fluororgano-/aminoalkyl-/alkyl-/alkoxy- or hydroxysiloxanes of the general formula II

R[—O—Si(OR)₂]_{w}[—O—Si(R⁰)(R¹)₁₋ₕ(OR)ₕ]ₓ[—O—Si{R^{a}(HX)_{g}}(CH₃)₁₋ᵢ(OR)ᵢ]_{y}[—O—Si(R²)₂ⱼ(OR)ⱼ]_{z}(OR) (II),

wherein R⁰ is a linear, branched, or cyclic alkyl group having 1 to 18 carbon atoms or a mono-, oligo- or polyfluorinated organoalkyl or organoaryl group of the formula (IIa) R³—Y_{#}—(CH₂)₂—, wherein R³ is a linear, cyclic, or branched mono-, oligo-, or polyfluorinated alkyl group having from 1 to 13 carbon atoms or a mono-, oligo-, or polyfluorinated aryl group, Y is a CH₂, O, or S group, wherein #=0 or 1,

R^{a} is an aminoalkyl group of the general formula (IIb) H₂N(CH₂)_{§}[(NH)_{$}(CH₂)_{&}]_{β}—, wherein 0≦§≦6, 0≦&≦6, $=0 if §=0 then β=1, $=1 if §>0 then β=1 or 2, and X is an acid radical from the series chloride, formate, and acetate wherein g=0 or 1 or 2 or 3,

h, i, and j, independently of one another, are 0 or 1,

groups R² are identical or different, and R² is a linear, cyclic, or branched alkyl group having from 1 to 18 carbon atoms,

R¹ is a linear, cyclic, or branched alkyl group having from 1 to 8 carbon atoms,

groups R are identical or different and are a hydrogen atom or a linear, cyclic, or branched alkyl group having from 1 to 4 carbon atoms,

x, y, z and w are identical or different, wherein x>0, y>0, z≧0, w≧0 and (x+y+z+w)≧2 and preferably (x+y+z+w)≦300, more preferably (x+y+z+w)≦100, in particular (x+y+z+w)≦40, and preferably x is a number from 1 to ≦300, more preferably from 1 to 40, in particular from 2 to 10, y is a number from 1 to ≦300, preferably from 1 to 40, in particular from 2 to 10, z is a number from 0 to 10, and w is a number from 0 to 10. All subvalues are included.

Suitable condensated and hydrolyzed oligomers and/or polymers of functionalized silanes (formulae Ia, Ib or II) are available as aqueous systems under the following commercial brand names: e.g. DYNASYLAN® HYDROSIL 1151, 2627, 2775, 2776, 8815, 2759, 2781, 2907, 2909, 2908, 2924, 2926.

Mixtures of functionalized silanes can be used to prepare the condensated and hydrolyzed oligomers and/or polymers.

In one embodiment, the silane content of the condensated and hydrolyzed oligomers and/or polymers of functionalized silanes in an aqueous systems can be in the order of 40 to 80% by weight based on the aqueous formulation. The silane content includes all values and subvalues therebetween, especially including 45, 50, 55, 60, 65, 70 and 75% by weight.

Preferably, present condensated and hydrolyzed oligomers and/or polymers of functionalized silanes an aqueous systems are commercially available under the tradename DYNASYLAN® HYDROSIL.

In one embodiment, the hydrosils are used as they are or diluted. Notably, commercially available hydrosils are aqueous solutions. These aqueous solutions can be further diluted as follows. Preferably, the present hydrosil systems are diluted in water so that the content of the hydrosil solution in water can be 0.5% to 100% by weight, preferably 5 to 25% by weight. Alternatively, alcohol or a mixture of alcohol and water may be can be used. The amount of commercial solution in water includes all values and subvalues therebetween, especially including 1, 2, 3, 4, 5, 6, 7, 8, 9, 10, 15, 20, 25, 30, 35, 40, 45, 50, 55, 60, 65, 70, 75, 80, 85, 90, 95, and 99% by weight. The water used for dilution is preferably deionized water.

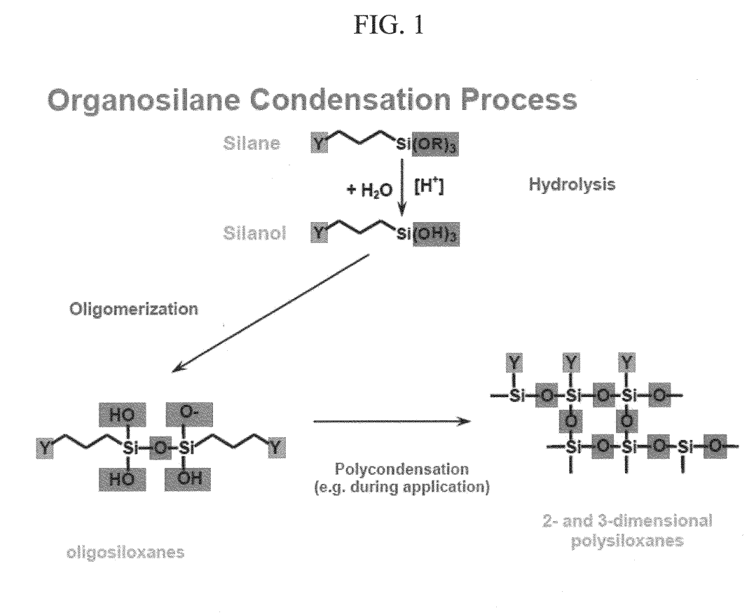

A non-limiting schematic for the organosilane condensation process is shown in FIG. 1. However, this application is not intended to be limited to the molecules or chemistry or theory shown in FIG. 1.

The condensation products of the hydrosil systems are polymeric, with a particle size between 0.5 and 35 nm, or preferably between 0.5 to 130 nm, and a weight average molecular weight from 1000-150000 g/mol, preferably between 4000 to 30000 g/mol, more preferably between 1000 to 50000 g/mol, even more preferably between 1000 to 5000 g/mol. They are in the form of an aqueous dispersion having a solids content between 1.5-40% by weight depending on the dilution applied, preferably between 1.5% to 10% by weight, based on the weight of the dispersion. The particle size of the condensation product includes all values and subvalues therebetween, especially including 1, 5, 10, 15, 20, 25, 30, 35, 40, 45, 50, 55, 60, 65, 70, 75, 80, 85, 90, 95, 100, 105 110, 115, 120 and 125 nm. The weight average molecular weight includes all values and subvalues therebetween, especially including 1200, 1400, 1500, 1600, 1800, 2000, 2200, 2400, 2500, 2600, 2800, 3000, 3200, 3400, 3500, 3600, 3800, 4000, 4200, 4400, 4500, 4600, 4800, 5000, 10000, 20000, 30000, 40000, 50000. 60000, 70000, 80000, 90000, 100000, 110000, 120000, 130000, 140000 g/mol. The solids content includes all values and subvalues therebetween, especially including 2, 4, 5, 10, 15, 20, 25, 30 and 35% by weight.

Organic polar solvents are preferably used for the condensated and hydrolyzed oligomers and/or polymers of functionalized silanes. For example, polar alcohols such as, but not limited to, ethanol, propanol, isopropanol, methanol, either alone or in combination with water. Preferably, water, more preferably distilled water, most preferably deionized water (18-19 MΩ·cm) is used as solvent.

In a preferred embodiment, compositions are used as corrosion protection compositions that contain (1) condensated and hydrolyzed oligomers and/or polymers of functionalized silanes which are completely hydrolyzed, (2) water as the solvent and (3) optionally additives, such as wetting agents, defoaming agents and color components such as colorants or pigments to increase the visibility of the anti-corrosion coating.

Method of Coating

The corrosion protection coating system is applicable to parts constructed of various metals, such as fence posts and wires; car parts, such as mufflers, car bodies, screws, bolts, springs, and the steel parts in tires; also included are metal parts used in construction, such as door handles, window studs, weight bearing parts, construction facades, tubes and pipes; as well as other metal construction parts used in the marine and aerospace industries.

The metal to which the corrosion protection coating can be applied is not particularly limited. Suitable metals include aluminum and the various aluminum alloys, cast iron, steel, steel alloys, stainless steel, magnesium, copper, zinc, galvanized steel. The metal may be surface treated. The surface treatment of the metal may comprise of chromating, phosphatizing, galvanizing and/or bronzing.

One application for the present invention is the pretreatment of metal parts and sheets that have already a galvanized coating, but still require an additional corrosion protection. Corrosion protection coatings of the present invention can be applied to any of the following metal parts consisting of the group of bare metal, phosphatized metal, chromated metal, bronzed metal, zinc plated metal, galvanized metal, and zinc nickel alloy.

The metal surfaces to be treated can be used as is, pre-cleaned or pretreated with other corrosion protection processes. The surfaces of the metal parts and pieces used in the present invention are preferably cleaned prior to the coating. Preferably, the surface is clean and can be perfectly wetted by water, preferably the surface has a contact angle of 0°. Any cleaning method to achieve this contact angle can be used.

The cleaning procedure can be performed by several methods, preferably by using an alkaline cleaner. The metal substrate is cleaned by immersion in a 5% cleaner solution at 70° C., followed by a deionized water rinse and drying by forced air. The criteria for cleanliness is a water break-free surface on the metal surface, meaning, the water has to wet the surface of the metal completely (or substantially completely).

A typical commercially available cleaner for the cleaning procedure is E-KLEEN 148-E, a low caustic and non-emusifiable cleaning agent, from EPI Electrochemical Products, Inc. Other cleaning agents include, but are not limited to, ALCONOX or ALCOJET from Alconox, Inc.

An alkaline cleaner is preferred for steel and aluminum. Optionally in the case of steel, the cleaning could include pre-cleaning with an alkaline cleaner and a subsequent acidic pickling step. In certain cases, the metal sheet and metal parts could be sandblasted or cleaned by plasma using a UV light source. It is also suitable to use solvents such as acetone, alcohol, MEK, chlorinated solvents such as perchloroethylene, or non-chlorinated solvents such as DOWCLENE to clean metal parts that are less soiled and oiled. However, solvent cleaning has limited use in industrial applications.

After the metal surface has been cleaned and treated within the scope of this invention, these will be compared to current conventional pre-treatment methods used in industry.

The most used conventional pretreatment methods (metal pretreatment refers to pretreating the metal prior to painting for corrosion protection and paint adhesion) are:

(1) iron phosphate, which depending on whether a final seal is used, can provide 250-500 hours of salt spray corrosion protection as well as provide adhesion for subsequent painting;

(2) zinc phosphate, depending on the weight of the coating, can provide typically 750-1000 hours of salt spray corrosion protection. Compared to iron phosphate, zinc phosphate provides better corrosion protection and better paint adhesion; and

(3) chromate (based mainly on Cr⁶⁺ or Cr³⁺ or combination thereof), is used mainly on aluminum and aluminum alloys but can be used on galvanized steel as well. Typically, chromating provides 100-500 hours of salt spray corrosion protection on aluminum without painting. With painting, the corrosion protection can vary depending on the aluminum alloy, chrome coating weight, paint system, etc.

During the coating method of the present invention, the metal surface is coated with the condensated and hydrolyzed oligomers and/or polymers of functionalized silanes of the present invention either by dipping, spraying, spin coating, frame coating or drum coating. The sample size is not particularly limited. The application of the coating can be repeated one or more times.

In one embodiment, the condensated and hydrolyzed oligomers and/or polymers of functionalized silanes were applied by immersing the cleaned bare metal panels, such as aluminum panels, into the formulation of condensated and hydrolyzed oligomers and/or polymers of functionalized silanes for a short period of time at room temperature. The immersion time is preferably 10 seconds to 10 minutes, more preferably, 30 seconds to 5 minutes, and even more preferably 1 minute to 2 minutes. The immersion time includes all values and subvalues therebetween, especially including 0.5, 1, 2, 3, 4, 5, 6, 7, 9, 10 minutes.

The corrosion protection composition can be applied one or more times to a metal surface, before or after drying.

After the immersion, the samples were dried. The drying temperature is not particularly limited and should be selected to be appropriate for the solvents used in the formulations. Preferably, the drying temperature is between 0 and 50° C., preferably however the drying is between 15 and 25° C., more preferably at room temperature. The drying temperature includes all values and subvalues therebetween, especially including 5, 10, 15, 20, 25, 30, 35, 40 and 45° C. The drying time is between 10 seconds and 30 minutes, preferably 20 seconds and 25 minutes, more preferably between 30 seconds and 20 minutes, most preferably between 5 and 15 minutes, most preferably at about 10 minutes. The drying time includes all values and subvalues therebetween, especially including 0.5, 1, 2, 3, 4, 5, 6, 7, 9, 10, 11, 12, 13, 14, 15, 20 and 25 minutes.

After drying, the samples were subjected to curing. For example, the samples may be cured in a curing apparatus such as an oven or on a heated surface such as a hot plate. In one embodiment, the samples are cured by IR radiation, preferably in an oven. The curing temperature may be between 30 to 200° C., preferably 40 to 150° C., more preferably 50 to 120° C. A preferred range is from 40 to 59° C. The curing temperature includes all values and subvalues therebetween, especially including 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190 and 195° C. In one embodiment, the samples can be placed in an oven with ventilator and exhaust at 30° C. to 200° C. For samples cured by IR radiation, the curing time is 5 to 50 seconds, preferably 10 to 20 seconds.

Preferably, the curing time is between 10 seconds and 2 hours, more preferably 10 seconds and 1 hour, more preferably 10 seconds and 30 minutes, more preferably 20 seconds and 25 minutes, more preferably between 30 seconds and 20 minutes, most preferably between 5 and 15 minutes, most preferably at about 10 minutes. The curing time includes all values and subvalues therebetween, especially including 0.5, 1, 2, 3, 4, 5, 6, 7, 9, 10, 11, 12, 13, 14, 15, 20, 25, 30, 45 minutes, 1, 1.2, 1.4, 1.6, 1.8 hours.

After the curing, the samples are removed from the curing apparatus and cooled to room temperature, if necessary, prior to painting.

In a preferred embodiment, the metal surface is treated as follows:

(1) Cleaning: alkaline cleaner, 2-10% by volume, immersion, 140-150° F., 2-10 minutes;
(2) Rinsing: deionized water, ambient, 30 seconds;
(3) Drying: pressurized air blow off;
(4) Silane Treatment: immersion, 1 minute, in 5 to 25 g of the condensated and hydrolyzed oligomers and/or polymers of functionalized silanes formulation (such as hydrosil) and 75 to 95 parts of deionized water
(5) Drying: oven, 60-200° C., cured for 10 minutes
(6) Painting: each sample/specimen is placed on a support in an exhaust cabinet, and sprayed by using a conventional siphon feed with an air pressure of 40-50 psi. All the samples were painted only in one side.
(7) Drying: oven, 60° C., cured for 30 minutes followed by 1 more hour at 60° C. Preferably the layer thickness of the cured coating of the corrosion protection composition of the present invention should be less than about 5 μm. More preferable are coating layers with less than 1.5 μm and even more preferably less than 0.5 μm. The layer thickness of the coating includes all values and subvalues therebetween, especially including 0.1, 0.2, 0.3, 0.4, 0.5, 0.6, 0.8, 1, 1.5, 2, 2.5, 3, 3.5, 4 and 4.5 μm.

After application of the coating of the present invention, a top coating, using for example a paint or lacquer, may be applied. See for example step (6) above. Suitable lacquers includes but are not limited to alkyl resin coatings, 1- and 2-K polyurethane coatings, aqueous polymer dispersions (acrylate, vinyl acetate, and polyurethane, epoxide), 1- and 2-K epoxy resins, as well as acryl-, polyester-, polyurethane- and epoxy powder coatings and UV curable coatings. These top coatings are cured under the conventional conditions used for curing such top coatings. The top coating thickness may be between 40 to 100 μm or more.

In the corrosion tests according to ASTM B117, cleaned bare metal panels were pre-treated with said condensated and hydrolyzed oligomers and/or polymers of at least one functionalized silane, cured at low temperatures (around 60° C.), and then painted. These were corrosion tested and compared with traditional standard pre-treatments such as iron phosphate, zinc phosphate and chromate.

In another embodiment, additional tests were run using bare cold rolled steel (CRS 1010 from CAT) and bare galvanized steel (EG E60) samples instead of aluminum following the procedures described above.

The test showed surprisingly that present condensated and hydrolyzed oligomers and/or polymers of at least one functionalized silane can be cured successfully at low temperatures, with the best results around 60° C. (140 F), but not limited to this temperature, as a pre-treatment prior to painting. The samples of cleaned bare metal pre-treated with a very thin layer (preferably less than 1 μm) of said condensated and hydrolyzed oligomers and/or polymers of at least one functionalized silane, dried, cured at low temperature (room temperature to 100° C., preferable 60° C.), and then painted, have passed 1000 hours of Salt Spray Test, and given as good results as traditional pre-treatments methods.

Non-painted samples have shown very limited protection, with exception of a conventional sol-gel formulation, a primer formulation of (DYNASYLAN® GLYEO, DYNASYLAN® MTES and DYNASYLAN® A) (Formulation No. 6 described below) which has passed 1900 hours without remarkable signs of rust (only 3 spots).

### ADVANTAGES OF THE PRESENT INVENTION

The process of the present invention is a substitute for conventional processes for metal pretreatment with heavy metals, in particular Cr⁶⁺, with a low VOC water-based system. The process of the present invention is safer and environmentally friendly. The process of the present invention is a low temperature process, preferably performed at about 60° C. (140° F.) and below, instead of high temperatures. Thus, this process is advantageous from the view point of cost savings.

In addition, the process of the present invention, can simplify the anticorrosion metal treatment by using, in one embodiment, the corrosion inhibiting composition of the present invention and a paint or lacquer. This also saves processing costs, water and waste treatment. In addition, a coating which is thinner than conventional coatings can be provided. This results in lower weight of the treated metal parts which is of importance in the aerospace industry.

Having generally described this invention, a further understanding can be obtained by reference to certain specific examples which are provided herein for purposes of illustration only, and are not intended to be limiting unless otherwise specified.

### EXAMPLES

### Example 1

3 kg HS-1 is mixed with 97 kg water in a reactor. 100 g BYK 348 (BYK-Altana) is added to the mixture.

A steel sheet (cold-rolled milling) is dipped into the mixture for 2 minutes. The coating is dried with forced air at 60° C. for 5 minutes.

### Example 2

1 kg HS-2 is mixed with 20 kg water in a reactor. An aluminum sheet is coated using a squeegee (4 μm) and dried with forced air at 60° C.

### Example 3

15 kg HS-2 is mixed with 300 kg water in a reactor. A cold-milled steel sheet is dipped into the mixture and the rendered coating is dried with forced air at 60° C.

### Example 4

The metal sheets from Example 2 and 3 are lacquered using a polyester powder coating (60-80 μm) as a top coat. The corner and edges are coated using a zinc dust coating. To evaluate the protection the coating is marred by scraping “X” through the coating into the metal. The metal sheets are subjected into a salt spraying chamber.

### Example 5

Comparison between traditional pretreatment and formulation according to the present invention according to corrosion test ASTM B117.

### SUMMARY

The effectiveness in corrosion protection of formulations according to the present invention was tested on pre-treated (formulations mentioned within this invention) and painted samples of bare ALUMINUM 6061 from ACT. These samples were compared with painted samples of ALUMINUM 6061, already purchased as pretreated with chromate, zinc phosphate, and iron phosphate+chrome final seal. For each case 6 samples of aluminum were prepared.

All the samples were placed in a Q-Fog cabinet and tested according to the standard ASTM B117. Samples were evaluated according to the standard ASTM D1654.

The results after 2000 hours test show that present hydrosil systems cured at 200° C. have similar corrosion protection effect on painted samples as traditional metal pre-treatments, but the most important effect is that some samples cured at 60° C. show the same level of corrosion protection as samples cured at 200° C. as well as chromate, a traditional metal pre-treatment.

Experimental

Silane Preparations

The formulation HS-1 was prepared by adding aminopropyltriethoxy silane to water until a 40 wt. % solution of the amino silane in water was obtained. After that, the alcohol of the hydrolysis was removed by distillation. The removed amount of alcohol was replaced by an equivalent amount of water.

HS-2 was prepared by mixing 5 parts of hydrosil coming from EP0716127B1 Example 5 and 95 parts of deionized (DI) water for 10 minutes. The samples were used 24 hours later.

A basic hydrosil system was prepared by mixing of 376.9 kg aminoethylaminopropyltrimethoxysilane (DYNASYLAN® DAMO) with 120.0 kg of methyltriethoxysilane. The mixture was added, under stirring, to 503.1 kg of water. After that, the alcohol of the hydrolysis (445.3 kg) was removed by distillation. The removed amount of alcohol was replaced by an equivalent amount of water.

HS-3 was prepared in two different concentrations.

One preparation was made by mixing 5 parts of the above described basic hydrosil system and 95 parts of DI water for 10 minutes.
The second sample was made by mixing 25 parts of the above described basic hydrosil system and 75 parts of DI water for 10 minutes.

A preparation of traditional sol-gel, based on a mixture of silanes, water and IPA (isopropyl alcohol) in an acidic environment (at pH 1.5) was prepared according to Formulation No. 6 as described in the Degussa brochure entitled “Innovative Sol-Gel Coatings with Sivento Silanes”, which is incorporated herein by reference in its entirety.

Formulation No. 6 was as follows.

DYNASYLAN® MTES 30 wt %, DYNASYLAN® GLYEO 30 wt %, DYNASIL® A 10 wt %, Methoxypropanol 22.4 wt %, water 7.5 wt %, and HCl (37%) 0.1 wt % were used. Silanes and solvent were added to a beaker followed by the water-acid mixture (adjusted to pH of approximately 1.5). The colorless turbid mixture became clear after approximately 2 minutes, and the temperature rose approximately 5 to 10° C. during the hydrolysis process. The formulation was used 48 hours after preparation.

Aluminum Samples

All the aluminum samples of ALUMINUM 6061 were provided by ACT. The acquired samples were bare aluminum (labeled as ACT ALUMINUM 6061T6 03X06X032 CUT ONLY UNPOLISH, chromate treated aluminum (labeled as ACT ALUMINUM 6061T6 03x06x032 A600 DIW UNPOLISH), zinc phosphate treated aluminum (labeled as ACT ALUMINUM B958 NO PARCOLENE DIW UNPOLISH), and iron phosphate treated aluminum with chrome seal (labeled as ACT ALUMINUM B1070 P60 DIW UNPOLISH).

Aluminum pretreated samples are used in this test as reference to evaluate the effect of the silanes. The reference samples were also painted but without cleaning process due they are already cleaned and pre-treated and ready to be used

All aluminum samples used to evaluate the formulations according to the present invention were non-treated bare aluminum samples.

Cleaning of Bare Aluminum Samples

A preparation of non-silicated cleaner E-KLEEN 148 E at a concentration of 2-10% by volume, preferable 5% v/v in DI water was made, then heated to 140-150° F. The aluminum panels were immersed in the solution for 1-2 minutes, then rinsed with DI water for 30 seconds at ambient temperature, and dried by blowing pressurized air.

During the rinsing process the cleanliness of the metal surface was determined by the water break-free test. The cleaner used was E-KLEEN E 148 which is a low caustic and non emulsifiable cleaning metal from EPI Electrochemical Products Inc.

Labeling of the Samples

All the samples were identified with a label according a previous designed test matrix.

Silane Treatment

Silane preparations were applied by immersing the cleaned bare aluminum panels into the silane preparation for 1 minute at room temperature. After the immersion the samples were hung for 10 minutes at room temperature, and then placed in an oven at 60° C. or 200° C. for 10 minutes. After the 10 minutes, the samples were taken out and allowed to cool down to room temperature.

Control of the Primer Thickness

The thickness of the primer was determined by using a portable tester Minitest 600B from ElektroPhysik. Prior to use, the instrument was calibrated with Gardco Coating Thickness Standards for non-ferrous and ferrous materials.

All thicknesses were measured to be between zero and 1 micron. Thicknesses under 1 micron could not be accurately measured with this instrument.

Paint

The paint used for the samples is known as Genesis 3.5, a low VOC Acrylic Polyurethane base. The paint base was mixed with the hardener GH 1091, the accelerator GA-1097 and the thinner in the following proportions: 200.65 g GE 3.5+48.30 g GH 1091+4.5 g of GA 1097+20 cc of thinner. All of above the paint components were purchased from Sherwin-Williams.

Painting

Each sample was placed on a support in an exhaust cabinet, and sprayed by using a conventional siphon feed with an air pressure of 40-50 psi. All the samples were painted only on one side. The samples were placed on a holder and placed for 30 minutes in an oven at 60° C. Later they were heated again for 1 more hour at 60° C.

Control of Thickness

The thickness for each sample was measured with the Minitest 600B mentioned above and noted.

Protection of the Sample Borders

The metal panel borders were covered by a tape in order to avoid oxidation on the edges of the panels.

Scribing of the Samples

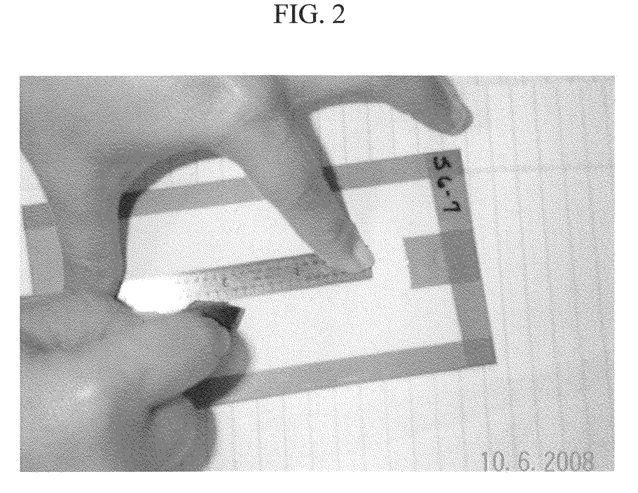

Every pre-treated and painted panel was scribed with a single line using a scribe tool as described in the standard norm ASTM D-1654-5. See FIG. 2.

Preparation of the Q-Fog Cabinet

The cabinet salt solution tank was filled with a solution of 5% by weight of NaCl in DI water, with a controlled pH of around 7, (6.5-7.2).

The flow conditions and the amount of salt water sprayed in the cabinet were controlled by placing graduated glass cylinders with a plastic funnel in the center and in the corner of the cabinet. The amount of water collected in each glass cylinder was measured and compared, and if necessary the pump flow and air pressure were adjusted to give a stable and equal sprayed volume of salt water. The specific gravity, the pH and the amount of salt solution collected in the cylinders were measured daily and noted. If necessary adjustments were made to the Q-Fog cabinet so that the following parameters were within the ASTM B117 specifications:

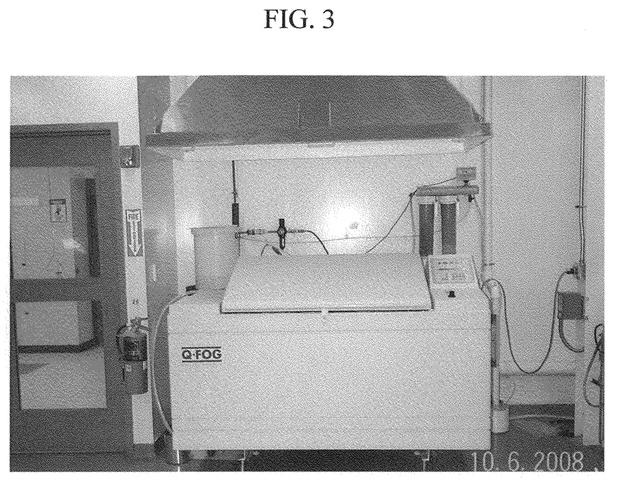

(1) the specific gravity was within 1.0255 and 1.0400; (2) the pH was between 6.5 and 7.2 and (3) the milliliters of salt solution collected were between 1-2 ml/hour. A Q-Fog cabinet is shown in FIG. 3.

Samples Placement

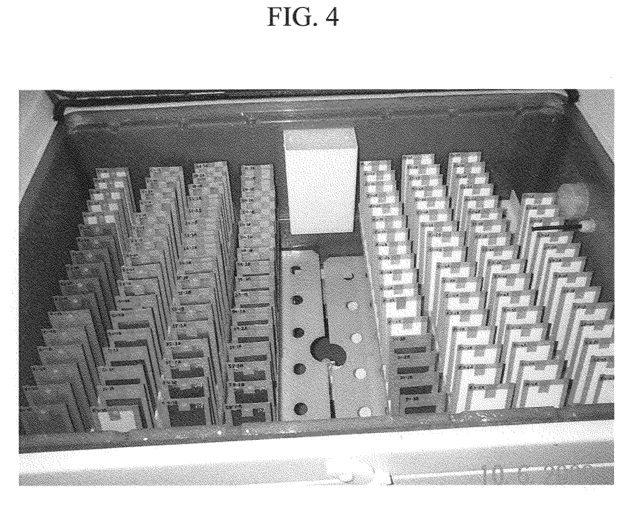

The samples were then placed according the Standard ASTM B 117 in an angle of 45° (FIG. 4) and the test initiated.

Control of Salt Water Level, Spray and Samples

Salt water level in the recipient of the Q Fog machine was controlled regularly and the salt water dissolution replace.

Spray flow was controlled by using the glass cylinders and measuring recollected water. pH and density was also measured and the data noted.

The samples were controlled with regularity and the samples which show signs of rust have affected the paint adhesion were removed, rinsed and scratched with a metal spatula. The rate of corrosion was evaluated according the Standard ASTM D1654, description in point 7.2 and table 1.

Control of Adhesion

Samples of pre-treated and painted bare aluminum, which were not submitted to salt spray test, were used for the following adhesion tests: Tape Test according ASTM D3359, Impact Test according ASTM D2794, and the Conical Mandrel test according ASTM D522-93a.

Only the bare aluminum samples failed to pass the impact and the conical mandrel tests.

Results

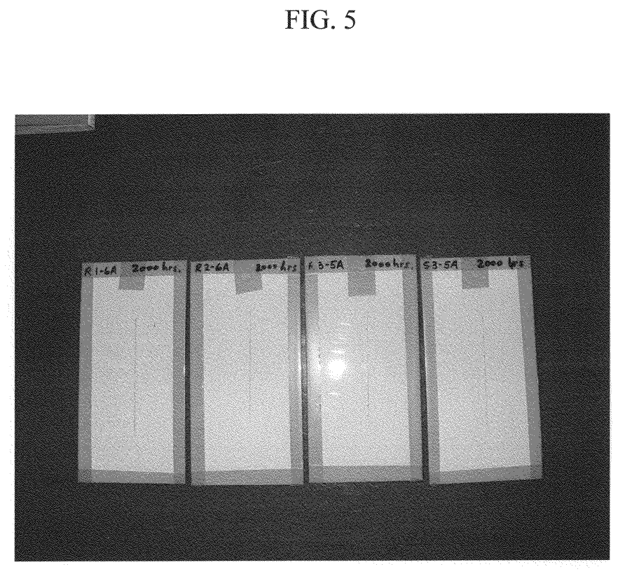

The results are shown in the Tables below and in FIG. 5.

Hydrosils and in particular the HS-2 (5%) provided protection against salt spray corrosion similar to that provided by traditional methods used here as reference, even at the low cure temperature of 60° C.

HS-3 cured at 60° C. show also an appreciable rate against corrosion after 1000 hours. Samples treated with hydrosil and cured at 200° C. show similar protection against corrosion as the standard methods.

In FIG. 5, samples R1, R2, R3 correspond to chromate, iron phosphate and chrome seal, and zinc phosphate respectively. Sample S3 correspond to a preparation of 5% HS-2 in DI water, and curing temperature 60° C.

From the point of view of the salt spray test according ASTM B117, hydrosil can substitute chrome (VI), iron phosphate and zinc phosphate. The good adhesion between hydrosil and the paint shows also that, in particular for the combination of acrylic PU and hydrosils, there is no need to apply an extra primer.

### CONCLUSION

It is therefore possible to substitute chrome and heavy metals by waterborne hydrosil with very low VOC, and save steps in the process of metal treatment, which mean savings in cost of production and water consumption and cleaning treatment.

Furthermore the low layer thickness of the hydrosil films is advantageous in applications where weight is an important factor, for example in aerospace applications.

BEST RESULTS OF THE TEST FOR ALUMINUM 6061

| | REFERENCES | | | | | | | | | | | | | |
|---|---|---|---|---|---|---|---|---|---|---|---|---|---|---|
| | | | Fe-Phos- | | CURED AT 60° C. | | | | CURED AT 200° C. | | | | | |
| | | | phate + | Zn- | | HS-2 | HS-3 | HS-3 | | HS-2 | HS-3 | HS-3 | Sol | |
| | | Chro- | Chrome | Phos- | | 5% in | 5% in | 25% in | | 5% in | 5% in | 25% in | Gel | |
| | Bare | mate | seal | phate | | water | water | water | | water | water | water | #6 | |
| | B | R1 | R2 | R3 | | S3 | S4 | S5 | | S8 | S9 | S10 | S11 | |
| Paint | 62 | 59 | 61 | 78 | | 68 | 54 | 67 | | 69 | 67 | 66 | 75 | Aver- |
| Thickness | | | | | | | | | | | | | | age |
| (μm) | 7 | 1 | 3.0 | 6.0 | | 68.0 | 17.0 | 5 | | 12.0 | 22.0 | 1.0 | 1.0 | Std Dev. |
| No. hours | 400 | 2000 | 2000 | 2000 | | 2000 | 500 | 1000 | | 2000 | 2000 | 1900 | 1900 | |
| test | | | | | | | | | | | | | | |
| Mean | 1 | 9 | 9 | 7 | | 9 | 5 | 6 | | 10 | 9 | 9 | 10 | |
| Creepage | | | | | | | | | | | | | | |
| Rating | | | | | | | | | | | | | | |

ADHESION TESTS

| | | | | | | | | | | | | | |
|---|---|---|---|---|---|---|---|---|---|---|---|---|---|
| e Identi- | B7 | R1-7 | R2-7 | R3-7 | S1-7 | S3-7 | S4-7 | S5-7 | S6-7 | S8-7 | S9-7 | S10-7 | S11-7 |
| fication | | | | | | | | | | | | | |
| Paint | 62.8 | 48.2 | 50.2 | 88.6 | 49.0 | 88.6 | 56.6 | 67.2 | 34.8 | 53.8 | 85.2 | 77.4 | 62.0 |
| Thickness | | | | | | | | | | | | | |
| Cross | 0 B | 5 B | 5 B | 5 B | 0 B | 5 B | 0 B | 0 B | 3 | 5 B | 5 B | 5 B | 5 B |
| hatch | | | | | | | | | | | | | |
| Impact | Failed | passed | passed | passed | passed | passed | passed | passed | passed | passed | passed | passed | passed |
| test | | | | | | | | | | | | | |

For the Paint thickness it has been used a Minitest 600B from ElektroPhysik, previously calibrated using the Gardco Coating Thickness Standard for non-ferrous and ferrous materials
For the cross hatch (Tape Test ASTM D-3359) has been used a Gardco Pat Temper II kit from Gardco
For the impact test (ASTM D2794-93 (2004)) has being used a Gardner Impact tester
For the Mandrel Test (ASTM D522-93a) it has being used a Malincrodt from BYR (Germany)

FOR ALUMINUM 6061
Sept. 06, 2007

| | REFERENCES | | | | HS-2 | HS-3 | HS-3 | HS-2 | HS-3 | HS-3 | Sol |
|---|---|---|---|---|---|---|---|---|---|---|---|
| | | | Fe-Phosphate + | Zn- | 5% in | 5% in | 25% in | 5% in | 5% in | 25% in | Gel |
| | Bare | Chromate | Chrome seal | Phosphate | water | water | water | water | water | water | #6 |
| | B | R1 | R2 | R3 | S3 | S4 | S5 | S8 | S9 | S10 | S11 |
| No. of samples | | | | | | | | | | | |
| test | | | | | | | | | | | |
| Paint Thickness | | | | | | | | | | | |
| (μm) | | | | | | | | | | | |
| No. hours test | | | | | | | | | | | |
| Mean Creepage | | | | | | | | | | | |
| Rating | | | | | | | | | | | |
| No. of samples | 6 | | | | | | | | | | |
| test | | | | | | | | | | | |
| Paint Thickness | 62 ± 7 | | | | | | | | | | |
| (μm) | | | | | | | | | | | |
| No. hours test | 400 | | | | | | | | | | |
| Mean Creepage | 1 | | | | | | | | | | |
| Rating | | | | | | | | | | | |
| No. of samples | | 6 | 6 | 6 | 6 | 3 | 3 | 6 | 6 | 3 | 6 |
| test | | | | | | | | | | | |
| Paint Thickness | | 61 ± 10 | 57 ± 7 | 63 ± 13 | 76 ± 17 | 54 ± 17 | 58 ± 5 | 70 ± 11 | 72 ± 12 | 65 ± 1 | 69 ± 15 |
| (μm) | | | | | | | | | | | |
| No. hours test | | 500 | 500 | 500 | 500 | 500 | 500 | 500 | 500 | 500 | 500 |
| Mean Creepage | | 10 | 10 | 10 | 10 | 5 | 7 | 10 | 9 | 9 | 10 |
| Rating | | | | | | | | | | | |
| No. of samples | | 5 | 5 | 5 | 5 | 3 | 3 | 5 | 5 | 3 | 5 |
| test | | | | | | | | | | | |
| Paint Thickness | | 58 ± 5 | 58 ± 5 | 66 ± 12 | 81 ± 13 | 48 ± 14 | 67 ± 5 | 69 ± 12 | 70 ± 12 | 70 ± 6 | 69 ± 17 |
| (μm) | | | | | | | | | | | |
| No. hours test | | 1000 | 1000 | 1000 | 1000 | 1000 | 1000 | 1000 | 1000 | 1000 | 1000 |
| Mean Creepage | | 10 | 9 | 9 | 10 | 3 | 6 | 10 | 9 | 2 | 9 |
| Rating | | | | | | | | | | | |
| No. of samples | | 2 | 2 | 2 | 2 | | | 2 | 2 | 2 | 2 |
| test | | | | | | | | | | | |
| Paint Thickness | | 59 ± 1 | 61 ± 3 | 78 ± 6 | 68 ± 3 | | | 69 ± 12 | 67 ± 22 | 66 ± 1 | 75 ± 1 |
| (μm) | | | | | | | | | | | |
| No. hours test | | 2000 | 2000 | 2000 | 2000 | | | 2000 | 2000 | 1900 | 1900 |
| Mean Creepage | | 9 | 9 | 7 | 9 | | | 10 | 9 | 9 | 10 |
| Rating | | | | | | | | | | | |

ADHESION TEST

| Sample Identi- | | | | | | | | | | | |
|---|---|---|---|---|---|---|---|---|---|---|---|
| fication | B7 | R1-7 | R2-7 | R3-7 | S3-7 | S4-7 | S5-7 | S8-7 | S9-7 | S10-7 | S11-7 |
| Paint | 62.8 | 48.2 | 50.2 | 88.6 | 88.6 | 56.6 | 67.2 | 53.8 | 85.2 | 77.4 | 62.0 |
| Thickness | | | | | | | | | | | |
| Cross | 0 B | 5 B | 5 B | 5 B | 5 B | 0 B | 0 B | 5 B | 5 B | 5 B | 5 B |
| hatch | | | | | | | | | | | |
| Impact | Failed | passed | passed | passed | passed | passed | passed | passed | passed | passed | passed |
| test | | | | | | | | | | | |

Numerous modifications and variations on the present invention are possible in light of the above teachings. It is therefore to be understood that within the scope of the appended claims, the invention may be practiced otherwise than as specifically described herein.

1. A method for corrosion protection of a metal surface, comprising:
coating a corrosion protection composition on said metal surface, thereby obtaining a coating; and
curing said coating at a temperature of from 20 to 120° C., to obtain a cured coating;
wherein said corrosion protection composition comprises a condensated and hydrolyzed oligomer and/or polymer of at least one functionalized silane.

2. The method of claim 1, wherein said oligomer and/or polymer has a cyclic, linear or branched structure represented by the formula
HO—[SiR¹(OH)—O]ₐ—[SiR²(OH)—O]_{b}—[Si(OH)₂—O]_{c}—H
wherein R¹ and R², are each independently, a linear or branched alkyl group having no substitution or at least one functional group selected from the group consisting of an alkylamino-, arylamino-, glycidyl-, alkyldiamino-, alkyltriamino-, hydrolyzed glycidyl-, methacryloxy-, acryloxy-, vinyl-, aryl-, fluoroalkyl-, polyethylenoxide- and alkylamine-N-alkyl-group, and wherein a, b and c are each independently smaller than 300, with c≧0.

3. The method of claim 1, wherein said metal of said metal surface is selected from the group consisting of iron, steel, aluminum, aluminum alloys, magnesium, copper, zinc, steel alloys, galvanized metal;
wherein said metal is optionally surface treated;
wherein surface treatment of said surface treated metal is at least one treatment selected from the group consisting of chromating, phosphatizing, galvanizing and bronzing.

4. The method of claim 1, further comprising applying an additional coating of said corrosion protection composition.

5. The method of claim 1, wherein said condensated and hydrolyzed oligomer and/or polymer comprises less than 0.5% of an alcohol produced during manufacturing of said condensated and hydrolyzed oligomer and/or polymer.

6. The method of claim 1, wherein said condensated and hydrolyzed oligomer and/or polymer is completely hydrolyzed.

7. The method of claim 1, wherein said condensated and hydrolyzed oligomer and/or polymer comprises a silicon-bonded aminoalkyl group.

8. The method of claim 1, wherein said condensated and hydrolyzed oligomer and/or polymer comprises less than 0.3% of volatile organic compounds.

9. The method of claim 1, wherein said cured coating has a thickness of up to 5 microns.

10. The method of claim 1, wherein said condensated and hydrolyzed oligomer and/or polymer is present as an aqueous formulation.

11. The method of claim 1, wherein said condensated and hydrolyzed oligomer and/or polymer has a concentration of 5 to 25% by weight in water.

12. The method of claim 1, wherein said condensated and hydrolyzed oligomer and/or polymer is selected from the group consisting of alkyl- or fluororgano-/aminoalkyl-/alkyl-/alkoxy- or hydroxysiloxanes of the general formula II
R[—O—Si(OR)₂]_{w}[—O—Si(R⁰)(R¹)₁₋ₕ(OR)ₕ]ₓ[—O—Si{R^{a}(HX)_{g}}(CH₃)₁₋ᵢ(OR)ᵢ]_{y}[—O—Si(R²)₂ⱼ(OR)ⱼ]_{z}(OR) (II),
wherein R⁰ is a linear, branched, or cyclic alkyl group having 1 to 18 carbon atoms or a mono-, oligo- or polyfluorinated organoalkyl or organoaryl group of the formula (IIa) R³—Y_{#}—(CH₂)₂—, wherein R³ is a linear, cyclic, or branched mono-, oligo-, or polyfluorinated alkyl group having from 1 to 13 carbon atoms or a mono-, oligo-, or polyfluorinated aryl group, Y is a CH₂, O, or S group, wherein #=0 or 1,
R^{a} is an aminoalkyl group of the general formula (IIb) H₂N(CH₂)_{§}[(NH)_{$}(CH₂)_{&}]_{β}—, wherein 0≦§≦6, 0≦&≦6, $=0 if §=0 then β=1, $=1 if §>0 then β=1 or 2, and X is an acid radical from the series chloride, formate, and acetate wherein g=0 or 1 or 2 or 3,
h, i, and j, independently of one another, are 0 or 1,
groups R² are identical or different, and R² is a linear, cyclic, or branched alkyl group having from 1 to 18 carbon atoms,
R¹ is a linear, cyclic, or branched alkyl group having from 1 to 8 carbon atoms,
groups R are identical or different and are a hydrogen atom or a linear, cyclic, or branched alkyl group having from 1 to 4 carbon atoms,
x, y, z and w are identical or different, wherein x>0, y>0, z≧0, w≧0 and (x+y+z+w)≧2.

13. The method of claim 3, wherein said metal is surface treated.

14. The method of claim 1, wherein said metal surface is cleaned prior to coating with said corrosion protection composition, to obtain a surface that is substantially completely wetted by water.

15. The method of claim 1, wherein said metal surface is pre-treated with a different corrosion protection process.

16. The method of claim 1, wherein said different corrosion protection process is iron phosphate treatment, zinc phosphate treatment or chromate treatment.

17. The method of claim 1, wherein said metal surface is immersed in said condensated and hydrolyzed oligomers and/or polymers for 10 sec to 10 min.

18. The method of claim 1, further comprising drying of said coating for 10 sec to 30 min at room temperature.

19. The method of claim 1, wherein said a curing time is between 10 sec and 2 h.

20. The method of claim 1, further comprising applying a top coating of a paint or lacquer and curing said top coating.

21. The method of claim 12, wherein x is a number from 1 to ≦300 and y is a number from 1 to ≦300 and w is a number from 0 to 10.

22. The method of claim 12, wherein x is a number from 1 to 40 and y is a number from 1 to 40 and w is a number from 0 to 10.
